(19) United States
(12) Patent Application Publication
(10) Pub. No.: US 2003/0045174 A1
(43) Pub. Date: Mar. 6, 2003

(54) Mounting arrangement for CRT socket board

(76) Inventor: Luc Tripod, Zurich (CH)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/940,949

(22) Filed: Aug. 28, 2001

(51) Int. Cl. H01R 33/20

(52) U.S. Cl. 439/675

(57) ABSTRACT

A socket for a cathode ray tube (CRT) forms part of a circuit board. The socket is positioned on the side of the circuit board away from the funnel portion of the CRT. The terminals which couple to the electron gun of the CRT are positioned along the side of the neck of the CRT, so that when the socket is engaged with the CRT, there is substantially no portion of the socket board which protrudes beyond the end of the neck portion of the CRT.

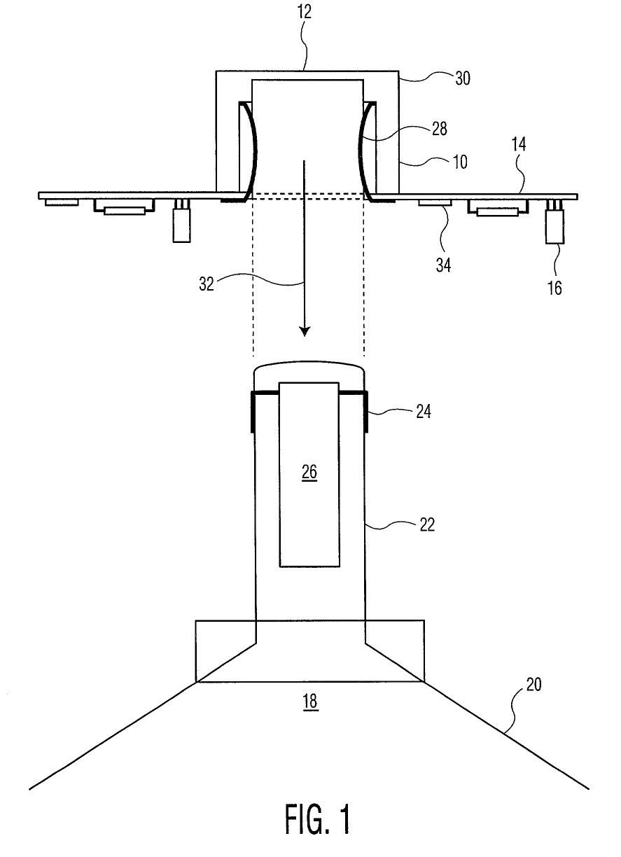

This invention relates to a socket for a cathode ray tube (CRT) in which the socket is part of a printed circuit board.

### BACKGROUND OF THE INVENTION

In modern television display apparatus, a socket for the electron gun of a CRT is constructed as part of a printed circuit board which may contain one or more video output amplifiers. This is done in order to keep the connections, between the outputs of the video amplifiers and the electrodes of the electron gun, as short as possible so as to avoid degradation of the video output signals, whose frequencies may exceed 5 megahertz. Generally, the socket for the CRT is mounted on the circuit board, so that when the socket is engaged with the CRT, the circuit board is positioned at the rear of the CRT with the socket.

The trend in modern CRT displays is to shorten the distance from the screen end of the cabinet to the rear of the cabinet. This can be accomplished in several ways. For example, a greater deflection angle will shorten the funnel portion of the CRT. At the present time, the largest deflection angle in commercial television apparatus is 110 [symbol] .

### SUMMARY OF THE INVENTION

The instant invention allows further shortening of the cabinet by shortening the protrusion of the CRT socket board beyond the end of the neck portion of the CRT. The invention provides an arrangement for coupling a CRT to a socket which is mounted on a circuit board, in which the CRT has a funnel portion and a neck portion containing an electron gun. The terminals for the electron gun are mounted along the side of the neck portion of the CRT. The circuit board is positioned with a first side which faces the funnel portion and a second side which faces away from the funnel portion. The socket has terminals which engage corresponding terminals on the neck portion of the CRT. The socket terminals are positioned on the second side of the circuit board. In this way, the socket and circuit board may be positioned with only a minimum protrusion to the rear of the end of the neck portion of the CRT.

### BRIEF DESCRIPTION OF THE DRAWING

In the Drawing:

The sole FIGURE shows an exploded view of a socket board and the rear portion of a CRT.

### DETAILED DESCRIPTION

The sole FIGURE shows a cathode ray tube (CRT) 18 having a funnel portion 20 and a neck portion 22 which contains an electron gun 26. The terminals 24 which connect to electron gun 26 are fed through the side of the neck portion 22 and lie along the surface of neck portion 22. The invention is equally applicable to a cathode ray tube whose gun terminals exit through the end of neck portion 22 and are folded forward along the surface of neck portion 22. Socket board 34 has electronic components 16 mounted thereon together with CRT socket 10 which contains spring contacts 28. Contacts 28 serve as terminals to connect to CRT terminals 24. Components 16 may be mounted on either side of socket board 34, as long as no component extends away from the funnel portion of the CRT further than the end of socket 10. Socket 10 is mounted on the side of the circuit board facing away from the funnel portion 20 of CRT 18. When socket 10 is engaged with neck portion 22 by mating the parts in the direction shown by arrow 32, there is substantially no protrusion of any portion of socket board 34 beyond the end of neck portion 22.

Socket 10 is provided with a back cover 12 which abuts the end of neck portion 22, and assists in properly positioning contacts 28 with respect to terminals 24. The Applicant has found that the use of the invention may reduce the depth of the cabinet by three to four centimeters.

What is claimed is:

1. An arrangement for coupling a cathode ray tube (CRT) to a socket which is mounted on a circuit board, said CRT having a funnel portion and a neck portion containing an electron gun, the terminals for said electron gun being positioned along the side of the neck portion of said CRT, said circuit board being positioned with a first side facing said funnel portion and a second side facing away from said funnel portion, said socket having terminals which engage corresponding terminals on said CRT, said socket terminals being positioned on said second side of said circuit board.

2. An arrangement as in claim 1, in which said circuit board has a plurality of components mounted thereon, none of said components extending away from said funnel portion further than the rearmost portion of said socket.

3. An arrangement of claim 2, in which said circuit board has a plurality of components mounted on said first side.

4. An arrangement of claim 1, in which said socket has a back cover which abuts the end of said neck portion.
